(19) United States
(12) Patent Application Publication
(10) Pub. No.: US 2026/0247154 A1
(43) Pub. Date: Aug. 20, 2026

(54) Hybrid Automotive Cybersecurity Monitoring Service

(71) Applicant: Zscaler, Inc., San Jose, CA (US)

(72) Inventor: Yuan-An Liu, Pleasanton, CA (US)

(73) Assignee: Zscaler, Inc., San Jose, CA (US)

(21) Appl. No.: 19/058,411

(22) Filed: Feb. 20, 2025

(51) Int. Cl. H04W 12/122

(52) U.S. Cl. CPC H04W 12/122

(57) ABSTRACT

Systems and methods are provided for enabling hybrid processing of cybersecurity analysis for embedded systems in vehicles, whereby local cybersecurity threats are detected locally on the vehicle itself, while a remote edge server can provide more comprehensive cybersecurity threat analysis. According to one implementation, an embedded system may be installed on or incorporated within a vehicle. The embedded system, for example, includes a wireless transceiver device and an operating system including at least a kernel and a cybersecurity agent. The cybersecurity agent includes minimal resources for contributing base level or lightweight functionality with respect to protection against vehicle cybersecurity attacks. The wireless transceiver device is configured to offload vehicle data to a cloud-based server, the cloud-based server configured for contributing detailed level or heavyweight functionality with respect to protection against the vehicle cybersecurity attacks.

### TECHNICAL FIELD

The present disclosure generally relates to cybersecurity systems and methods. More particularly, the present disclosure relates to hybrid systems in which lightweight cybersecurity agents are embedded within computing systems of motor vehicles for local security monitoring, while vehicle data can be wirelessly transmitted to a cloud-based server for more comprehensive security monitoring.

### BACKGROUND

Vehicles manufactured today generally rely more and more on sophisticated software systems and control modules. For example, software can be built on Linux systems, such as Automotive Grade Linux (AGL). With the increase in computing technologies within a vehicle, an unfortunate increase in security issues has also arisen. Currently, there are few (if any) cybersecurity solutions for reducing or eliminating various types of malicious cybersecurity attacks on the computing systems of vehicles that can cause safety and identity problems. Therefore, there is a need for systems and methods to protect against these cybersecurity attacks waged on embedded systems with motor vehicles, especially during operation of these vehicles on the road.

### BRIEF SUMMARY

The present disclosure is related to a hybrid system in which cybersecurity can be performed both locally and remotely. On the local stage, a computing system may be embedded in a vehicle, whereby the embedded system may include “lightweight” or base-level cybersecurity processing. On the remote stage, a multi-vehicle server may be configured to wirelessly receive vehicle data from multiple vehicles on the road to provide “heavyweight” or detailed-level cybersecurity processing.

Therefore, according to one implementation, an embedded system (e.g., on-board computer system) may be installed on or incorporated within a vehicle. The embedded system may include a wireless transceiver device and an operating system that includes at least a kernel and a cybersecurity agent (e.g., kernel-level security agent). The cybersecurity agent, for instance, includes minimal resources for contributing base level or lightweight functionality with respect to protection against vehicle cybersecurity attacks. Also, the wireless transceiver device may be configured to offload vehicle data to a cloud-based server (e.g., vehicle security server). The cloud-based server, for instance, may be configured for contributing detailed level or heavyweight functionality with respect to protection against the vehicle cybersecurity attacks.

In some embodiments, the cybersecurity agent may be configured to be hooked into the kernel without significantly modifying existing code of the kernel. The cybersecurity agent may be configured to leverage privileged code running in a kernel space of the operating system. The privileged code, for example, may be extended Berkeley Packet Filter (eBPF) that allows visibility into kernel-level events and kernel-level monitoring.

Furthermore, according to some embodiments, the embedded system within the vehicle may further include on-board sensors configured to detect operational parameters of the vehicle, the operational parameters including at least the vehicle data offloaded to the cloud-based server. For example, the cybersecurity agent may be configured to utilize the operational parameters to locally detect real-time anomalies and potential cybersecurity threats, and the cloud-based server may be configured to utilize the operational parameters to remotely detect additional anomalies and potential cybersecurity threats. The action of detecting the operational parameters may include monitoring system calls, process activity, network traffic, and/or file read/write operations.

The embedded system may be arranged in one or more control modules of the vehicle, the one or more control modules including at least an Electronic Control Unit (ECU). In some embodiments, the operating system may be configured in Linux or Automative Grade Linux (AGL). The protection against vehicle cybersecurity attacks, for example, may include defending against a) an autopilot function attack, b) a self-driving function attack, c) an autonomous lane change detection attack, d) a vehicle control module attack, e) a personal data exfiltration attack, f) a Personal Identifiable Information (PII) access or manipulation attack, g) a telematics access or manipulation attack, h) an infotainment system attack, i) a crypto mining attack, j) an on-board Machine Learning (ML) model attack, and/or k) a navigation function attack. In some embodiments, the cybersecurity agent and cloud-based server may be further configured to contribute remediation actions to defend against the vehicle cybersecurity attacks, the remediation actions including a) blocking access to vehicle operations, b) blocking access to personal data, c) preventing writing to config files, d) blocking access to control modules or memory resources, and/or e) blocking false notifications.

The wireless transceiver device, in some embodiments, may include at least a 5G module configured to transmit the vehicle data to the cloud-based server via one or more mobile base stations and/or stationary transportation devices. The 5G module, for example, may be further configured to receive analysis results from the cloud-based server, where the analysis results may include security status information and alerts with respect to the protection against the vehicle cybersecurity attacks. The 5G module, for example, may be configured to transmit logs, telemetry, telematics, system calls, network packets, and processes over a cellular connection to the cloud-based server. In some embodiments, the cloud-based server may be configured as a backend server or edge server having one or more microservices for contributing the detailed level or heavyweight functionality with respect to protection against the vehicle cybersecurity attacks. The cybersecurity agent may be configured with open-source code and may be agnostic to vehicle manufacturer and vehicle make and model information.

According to another implementation, the present disclosure may also be directed to a cloud-based, multi-vehicle server configured to perform the cybersecurity processing on the remote stage. In one implementation, the cloud-based, multi-vehicle server may include an Application Programming Interface (API) gateway configured to remotely receive vehicle data from each of one or more vehicles. Also, the cloud-based, multi-vehicle server may include a microservice module configured for cybersecurity analysis for each of the one or more vehicles, wherein each of the one or more vehicles may be configured to contribute base level or lightweight functionality with respect to protection against vehicle cybersecurity attacks waged on the respective vehicle. The cloud-based, multi-vehicle server may further include a fabric architecture configured to provide high-speed and efficient interconnection among multiple components of the cloud-based, multi-vehicle server for contributing detailed level or heavyweight functionality with respect to protection against the vehicle cybersecurity attacks.

In some embodiments, each of the vehicles serviced by the cloud-based, multi-vehicle server may include an embedded system installed thereon. The embedded system, for example, may include a) a wireless transceiver device for communication with the API gateway and b) an operating system including at least a kernel and a cybersecurity agent. The cybersecurity agent, for example, may include minimal resources for contributing the base level or lightweight functionality.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a system diagram illustrating a vehicle data security network, according to various embodiments.

FIG. 2 is a diagram illustrating operational steps of the vehicle data security network of FIG. 1, according to various embodiments.

FIG. 3 is a block diagram illustrating the on-board security agent shown in FIG. 1, according to various embodiments.

FIG. 4 is a block diagram illustrating the vehicle security server shown in FIG. 1, according to various embodiments.

### DETAILED DESCRIPTION

Again, the present disclosure relates to systems and methods for performing cybersecurity services for protecting computing systems of motor vehicles. As described herein, the security measures taken to prevent or reduce attacks can be performed at a first stage on the vehicle itself. This stage may include lightweight security processes. In addition, a second stage may involve the wireless transmission of vehicle data to a remote server. At this stage, the server can perform more in-depth security procedures for multiple vehicles. One advantage to having a lightweight agent on the individual vehicles is that this agent can include generic hardware and/or software resources that can be agnostic to the vehicle make and model. Also, using a secure cloud-based system or Zero Trust system, multiple vehicles can securely transmit their locally monitored vehicle data to the remote server for performing a more heavyweight type of security processing. The results of the heavy processing can then be securely transmitted back to the individual vehicles via the Zero Trust system to inform the drivers or passengers of security issues that may need to be resolved.

In particular, according to various implementations as discussed in the present disclosure, a vehicle having an embedded system (e.g., on-board computer system) may have a specific vehicle operating system. A common vehicle operating system is Linux or Automotive Grade Linux (AGL). The innovation described in the present disclosure includes the hooking of a “security agent” that can be embedded in the vehicle operating system, such as an agent on the kernel level that can be hooked into the existing kernel of the vehicle operating system. This security agent may include lightweight, base-level, generic, open-source code that is configured to perform cybersecurity processing on the kernel level. Thus, the security agent can quickly and efficiently monitor for and handle anomalies in the normal operations of the vehicle and can then reduce or eliminate various types of malicious attacks on the computing system of the vehicle. In addition to this local security phase for protecting against security attacks waged on the vehicle, vehicle information (e.g., operational parameters) can be wirelessly transmitted to a remote server (e.g., via 5G systems) to perform a greater level of security.

One apparent solution may include deploying a wide spectrum of endpoint security processing. However, a problem with this concept is that such a system would require greater computational power than what may normally be possible on an embedded system (e.g., Electronic Control Unit (ECU), etc.) on a vehicle. Also, this heavyweight system would need to be customized for each type of vehicle manufactured today and would need to be updated for new vehicles produced in the future. As such, when monitoring is performed on a Linux-based system, it would normally require the programmer to create customized kernel modules for the specific vehicles.

Furthermore, the kernel-level security agent incorporated in the vehicle operating system, as described in the present disclosure, may be configured to leverage an extended Berkeley Packet Filter (eBPF). With the eBPF deployed in the base agent, it is possible to tap into the kernel to read system information (e.g., system calls, vehicle operational conditions, etc.). In this way, it is possible to obtain a good amount of vehicle information without heavy processing tasks. Also, the eBPF can be hooked to the kernel without the need to actually modify the existing kernel code. Again, this can allow the use of a generic or open-source script without the need to load code into the kernel itself, which could only be done by the vehicle manufacturer or Linux system developer.

### Vehicle Security Network

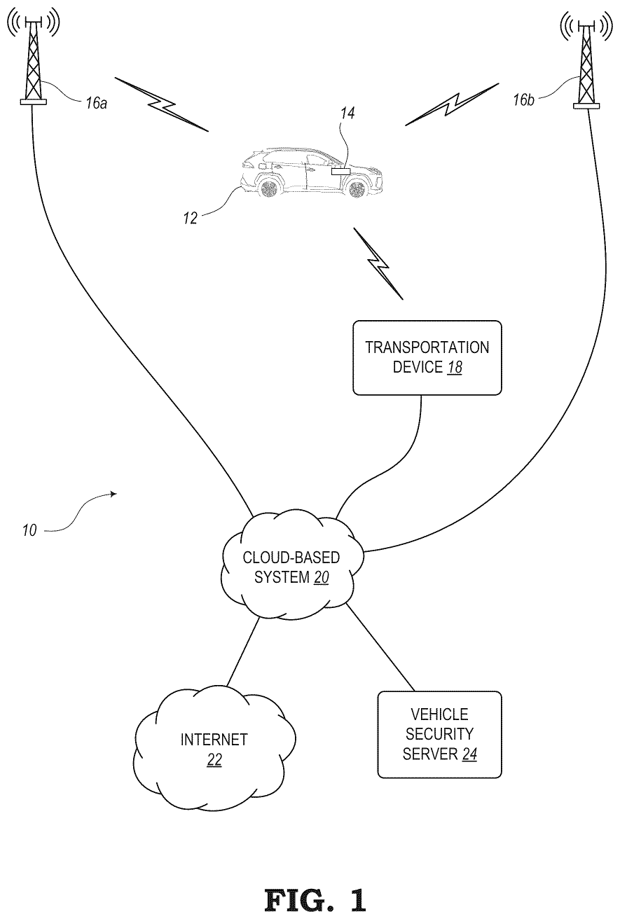

FIG. 1 is a system diagram illustrating an embodiment of a vehicle security network 10 configured for providing cybersecurity for a vehicle 12. Specifically, the vehicle 12 includes an on-board computer system 14 (e.g., embedded system, security agent, cybersecurity module, etc.). The vehicle security network 10 further includes mobile base stations 16a, 16b, a transportation device 18, a cloud-based system 20 connected to the Internet 22, and a vehicle security server 24. Although the vehicle security network 10 is shown in a simplified form in FIG. 1, it should be noted that the vehicle security network 10 may include any number of vehicles, any number of mobile base stations, and any number of transportation devices.

With the on-board computer system 14 as described in the present disclosure, the vehicle 12 is able to perform local monitoring of cybersecurity issues in the vehicle 12 itself. In addition, the vehicle 12 (and/or the on-board computer system 14) includes a wireless transmission device (not shown in FIG. 1) to communicate telemetry data (e.g., vehicle operational information, cybersecurity information, etc.) to the vehicle security server 24 via the cloud-based system 20, whereby the vehicle security server 24 can then perform more extensive vehicle monitoring functions, particularly with respect to cybersecurity issues directed to the vehicle 12. When the vehicle security network 10 includes multiple vehicles, the vehicle security server 24 may be configured to monitor the operations and security of each of these vehicles.

The vehicle 12 may be configured to communicate wirelessly with one or more of the mobile base stations 16a, 16b (or other mobile base stations) and may use any suitable handover or handoff capabilities as needed during travel. The mobile base stations 16a, 16b can then communicate the vehicle operational and security data to the vehicle security server 24. Communication from the mobile base stations 16a, 16b to the vehicle security server 24 may involve any suitable combination of wired (e.g., Ethernet) and/or wireless connectivity. The mobile base stations 16a, 16b may include any suitable combination of cellular tower, antennas, satellites, radio equipment, transceivers, mobile switches, etc.

Also, the vehicle 12 may be configured to communicate wirelessly with the transportation device 18 (or multiple transportation devices), which can then communicate the vehicle operational and security data to the vehicle security server 24. The transportation device 18 may be any standalone or built-in device configured to relay the vehicle information to the vehicle security server 24. For example, the transportation device 18 may be built into traffic signs, traffic signals, traffic monitoring systems, traffic sensing systems, etc. Also, the transportation device 18 may be built into buildings, bridges, roadways, etc. Communication with the mobile base stations 16a, 16b and transportation device 18 may involve 5G technology or other suitable wireless communication standards and protocols.

### Local and Remote Security Monitoring

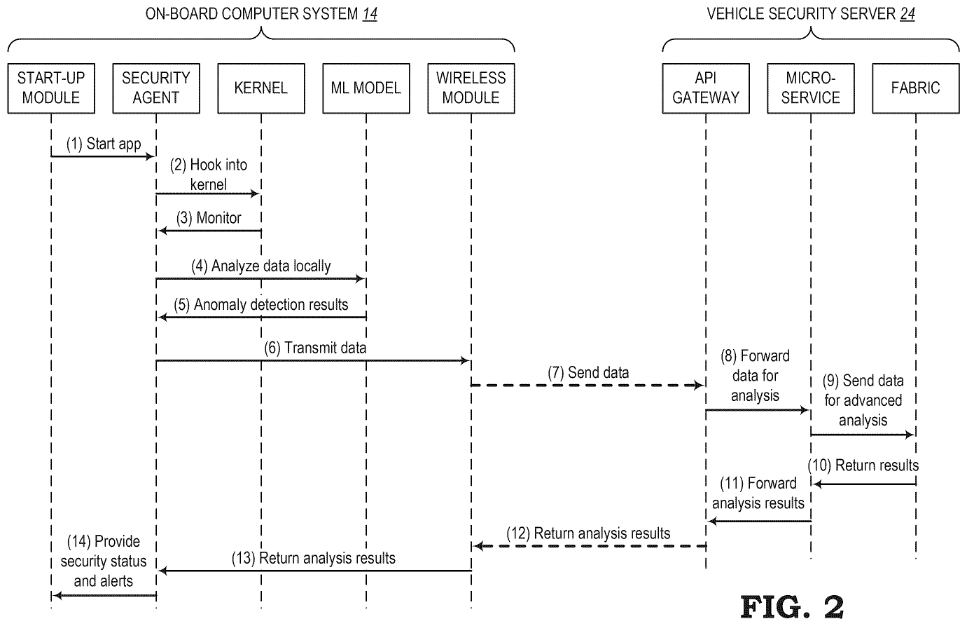

FIG. 2 is a diagram illustrating an embodiment of a procedure that includes operational steps performed by the various components of the vehicle security network 10. In this embodiment, the procedure includes the steps taken by the two main components (i.e., the on-board computer system 14 and the vehicle security server 24). As shown, the on-board computer system 14 includes a start-up module (e.g., User Interface (UI) device, infotainment app, bootstrapping module, ignition system, etc.), a security agent, a kernel, a Machine Learning (ML) model, and a wireless module (e.g., radio, mobile device, antenna, cellular module, 5G device, etc.). The vehicle security server 24, as shown, includes an Application Programming Interface (API) gateway, one or more microservices, and a fabric.

The procedure includes (1) starting an app (e.g., application of the security agent), (2) hooking the security agent into the kernel, and (3) monitoring vehicle parameters (e.g., operational data, security issues, etc.). Next, the procedure include (4) using the security agent to analyze the data locally, using the ML model, where the ML model is configured to (5) provide anomaly detection results back to the security agent. The security agent can perform various remediation steps, if necessary, to protect the vehicle against attacks. Also, the security agent may be configured to (6) transmit vehicle data to the wireless module, which can then (7) send the data wirelessly to the vehicle security server 24.

At this point, the API gateway of the vehicle security server 24 is configured to receive the data from the vehicle and (8) forward the data to the microservice (e.g., cybersecurity service) for analysis. The microservice also (9) sends the data to the fabric for advanced analysis. The fabric performed more advanced analysis on the data and then (10) returns the results. The microservice may then be configured to (11) forward the analysis results to the API gateway, which then (12) returns the analysis results back to the specific vehicle. Next, the wireless module of the on-board computer system receives the analysis results and (13) returns these results to the security agent. The security agent is then configured to (14) provide the security status and alerts to the start-up module for display of the results to the driver and/or passengers.

Therefore, in the realm of vehicle cybersecurity, the security agent may be deployed for gaining kernel-level control over the general computational and security functions of the vehicle. The security agent may utilize extended Berkeley Packet Filter (eBPF) technology within the kernel of the operating system in the vehicle. The security agent may be configured to detect anomalous activities locally, while offloading some data to the cloud-based infrastructure (e.g., vehicle security server 24) for enhanced processing and analysis. One goal of the security agent may be to detect and prevent malicious software or anomalies in the vehicle's onboard Linux operating system (e.g., self-driving modules, telematics, infotainment, etc.). Also, it can protect personal data and vehicle control systems from unauthorized access or manipulation.

As automobiles become increasingly connected and reliant on Linux-based operating systems such as Automotive Grade Linux (AGL) and Android-based Linux distributions, they become susceptible to cybersecurity threats. Traditional endpoint security software is often too resource-intensive for vehicle hardware, and existing security solutions require kernel modifications that may not be feasible due to proprietary restrictions imposed by vehicle manufacturers.

However, the systems and methods of the present disclosure provide a lightweight security agent that leverages eBPF technology to monitor kernel-level system activity in the vehicle's operating system. This agent efficiently collects system information (e.g., system calls, socket connections, file access, etc.) without modifying the existing kernel code. The collected data is transmitted from the wireless module via a 5G network to the cloud-based infrastructure (e.g., vehicle security server 24) for analysis. The vehicle security server 24 may include ML models and algorithms as well to identify potential threats (e.g., malware infections, unauthorized data exfiltration, attempts to interfere with the vehicle's autonomous driving functionalities, etc.).

Again, the security agent may be implemented using eBPF. As such, the security agent may be deployed within the vehicle's Linux-based kernel, utilizing the eBPF to retrieve detailed system telemetry and telematics data. Also, eBPF may be configured to enable the agent to gather information on process execution, network traffic, and file system access without requiring proprietary kernel modifications. The security agent can operate in a lightweight manner to ensure minimal impact on the vehicle's computing resources.

Due to the limited computational power of in-vehicle hardware compared to traditional data center clusters, the security agent may be configured to perform preliminary data collection and filtering within the vehicle. This allows for quick turnaround of easily identifiable issues. Also, the wireless module (e.g., 5G-enabled modem) may be integrated within the vehicle to facilitate the secure transmission of collected data to the cloud-based infrastructure. Then, the vehicle security server 24 or other cloud-based microservices can perform computationally intensive security analyses (e.g., anomaly detection, malware identification, behavioral analysis, etc.).

For example, the cybersecurity system of the present disclosure may be configured to perform locally processed and remotely processed threat detection, while using a combination of the processing capabilities to further enable mitigation of security threats. The security agent may be configured to identify malicious activities (e.g., unauthorized modifications to system files, anomalous process behaviors, suspicious network connections, etc.). The eBPF module may allow for real-time monitoring of HTTP headers and packet transmission to detect unauthorized data exfiltration. By comparing operational telemetry with normal behavioral baselines established through machine learning, the system can identify deviations indicative of cyber threats. In particular, the security agent may be configured to leverage eBPF to monitor system calls, process activity, network traffic, and file read/write operations. The eBPF allows visibility into kernel-level events without requiring custom kernel modules, making it more portable across different car manufacturers' Linux builds.

Furthermore, the vehicle security network 10 may be configured to provide protection against vehicle-specific threats. For example, the security agent can mitigate risks associated with crypto mining attacks, which exploit a vehicle's computing power to perform unauthorized blockchain computations and degrading vehicle performance. The security agent can also detect potential interference with autonomous driving modules by monitoring access to critical sensor data, configuration files, and system processes. The vehicle security network 10 can prevent the leakage of Personal Identifiable Information (PII) and other sensitive information, which can be achieved by identifying unauthorized data access and transmission attempts.

Another advantageous feature of the vehicle security network 10 is the use of offline security mechanisms. That is, the vehicle security server 24 may still be utilized in scenarios where the vehicle loses connectivity to the cloud. Also, onboard security mechanisms may be configured to ensure continued protection by storing logs and enforcing predefined security policies. Once connectivity is restored, the system synchronizes data with the cloud for further analysis and threat response.

In addition, the lightweight security agent, as mentioned above, may include cross-vehicle compatibility, whereby it can be designed to be universally compatible across different vehicle manufacturers, makes, and models by standardizing the eBPF-based data collection. The primary computational burden may reside in the cloud, minimizing the need for manufacturer-specific adaptations. The lightweight design and cloud offloading features are configured to emphasis the goal of keeping the agent lightweight due to the limited resources on automotive systems. The vehicle can send logs and telemetry (e.g., system calls, network packets, processes, etc.) over a 5G or cellular connection to cloud services for in-depth analysis, such that most of the heavy computations (e.g., machine learning, advanced analytics, real-time threat detection, etc.) can be offloaded to the cloud.

Also, the vehicle security network 10 may include ML-based analysis and threat response. The cloud-based infrastructure may be configured to apply ML algorithms to analyze telemetry data from multiple vehicles, identifying patterns of malicious activity. This aggregated intelligence allows the system to detect emerging threats and update security policies dynamically. Also, the threat response actions may include alerting vehicle owners, isolating compromised processes, and applying security patches (e.g., over-the-air (OTA)).

The functionality of the security agent may include monitoring the processes that are being run in the vehicle operating system, monitor file system changes, monitor network connections, etc. Also, the security agent can identify suspicious behaviors (e.g., unexpected file writes, connections to suspicious IP addresses, etc.). Logs may be streamed to the cloud, which then may apply anomaly detection and learn from aggregate data across one or more vehicles or a fleet of vehicles.

Thus, the vehicle security network 10 is configured to provide an advanced, lightweight cybersecurity solution for modern vehicles by utilizing eBPF for real-time kernel monitoring and cloud-based threat analysis. By offloading computationally intensive security tasks to the cloud, the system ensures robust protection without overburdening in-vehicle hardware. The security agent effectively addresses concerns such as malware infections, unauthorized data exfiltration, crypto mining attacks, and interference with autonomous driving functions, thereby enhancing vehicle safety and security in an increasingly connected automotive landscape.

Some threat scenarios may include crypto mining or botnets, where attackers could misuse the car's onboard computer for unauthorized tasks, affecting performance and safety. Also, attackers could manipulate control features (e.g., self-driving control), where malicious actors might alter sensor configurations or self-driving logic, threatening driver safety.

Overall, the systems and methods of the present disclosure may aim to enhance automotive cybersecurity by deploying a lightweight, kernel-level monitoring agent for local monitoring. Also, it can forward rich telemetry data to the cloud for comprehensive, scalable analysis. This procedure can ultimately protect both the vehicle's operational integrity and the driver's personal data.

### Embedded On-Board Computer System

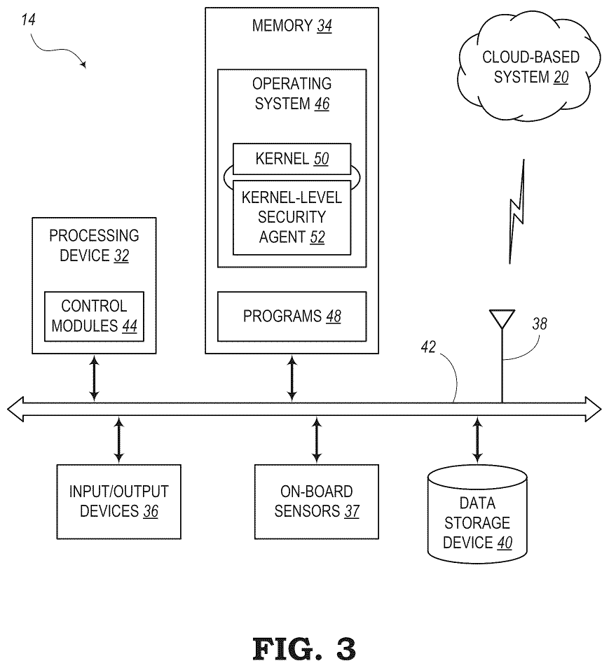

FIG. 3 is a block diagram illustrating an embodiment of the on-board computer system 14 described with respect to FIGS. 1 and 2. In some embodiments, the on-board computer system 14 may be an embedded system installed in or otherwise deployed within the vehicle 12. Also, the on-board computer system 14 may be any security agent for providing a first line of defense against cyber-attacks, whereby additional remediation efforts may be conducted by a remote system.

As shown in FIG. 3, the on-board computer system 14 includes a processing device 32, memory 34, Input/Output (I/O) devices 36, on-board sensors 37, a wireless communication device 38, and a data storage device 40, each interconnected with each other via a local interface 42 (e.g., Controller Area Network (CAN) bus). The processing device 32 may include one or more control modules 44, such as an Electronic Control Unit (ECU), also known as an Electronic Control Module (ECM), or other automotive electronics that control one or more of the electrical systems or subsystems in the vehicle 12. Other control modules 44 embedded in the on-board computer system 14 may include engine control module (ECM), powertrain control module (PCM), transmission control module (TCM), brake control module (BCM or EBCM), central control module (CCM), central timing module (CTM), general electronic module (GEM), body control module (BCM), suspension control module (SCM), etc. In some embodiments, the different control modules 44 may be implemented in separate computers.

The processing device 32 is configured to execute instructions stored in the memory 34 to perform various computing tasks. The memory 34 may include volatile memory such as random access memory (RAM) for temporary data storage and non-volatile memory such as read-only memory (ROM) for storing essential system instructions. The one or more I/O devices 36 may facilitate communication with external peripherals and users, including touchscreens, keyboards, infotainment systems, etc.

The on-board computer system 14 may also be equipped with a power supply unit (PSU) (e.g., vehicle battery, etc.) to provide electrical power to all internal components, ensuring proper functionality and operation. The PSU may include voltage regulation mechanisms and safety features to protect against power surges and fluctuations, thereby safeguarding the integrity of the system and connected peripherals.

In conjunction with the hardware components, the on-board computer system 14 includes software components, such as one or more operating systems 46, device drivers, and application programs 48. These software elements enable the on-board computer system 14 to manage hardware resources efficiently, execute user commands, and run various applications tailored to specific tasks or purposes. As shown, the operating system 46 includes a kernel 50 and a kernel-level security agent 52, which may be tied together in some embodiments.

Again, modern vehicles increasingly rely on sophisticated software systems, often built on Linux, such as Automotive Grade Linux (AGL), necessitating robust security solutions. For example, the operating system 46 or software platform may be configured as AGL. The kernel-level security agent 52 may be configured as an “auto shield,” so to speak, as a lightweight security agent that leverages eBPF for efficient monitoring with minimal resource impact. The kernel-level security agent 52 (e.g., eBPF) may be configured to hook into the kernel 50 to observe process and network usage, thereby ensuring real-time detection of anomalies and potential threats.

It may be understood that AGL is a collaborative, open source project that brings together automakers, suppliers, and technology companies for the purpose of building Linux-based, open source software platforms for automotive applications that can serve as de facto industry standards. AGL is configured to address all software in the vehicle (e.g., infotainment, instrument cluster, head-up-display (HUD), telematics, connected car, advanced driver assistance systems (ADAS), functional safety, autonomous driving, self-driving, etc.).

It may also be understood that eBPF is a technology that can run programs in a privileged context such as is shown in FIG. 3, in which the eBPF may be included in the kernel 50 of the operating system 46. It may be used to safely and efficiently extend the capabilities of the kernel 50 at runtime, without requiring changes to source code of the kernel 50 or loading kernel modules. Safety may be provided, for example, through an in-kernel verifier, which may be configured to perform static code analysis and reject programs that might tend to crash, hang, freeze, stop responding to user input, include issues (e.g., bugs, infinite loops, insufficient memory, slow network, logical errors, etc.), or might otherwise interfere with the kernel 50 negatively.

Thus, the lightweight agent can include eBPF as a powerful framework in the Linux kernel that allows small, “sandboxed” programs to run safely in kernel space without the need for custom kernel modules. It provides hooks into various kernel-level events (e.g., network packets, system calls, file operations, etc.), enabling real-time visibility into system behavior. Because eBPF programs can attach dynamically to these hooks, a security agent can collect detailed information (e.g., process and network activity) with minimal performance overhead. This lightweight design is especially valuable on resource-constrained systems, such as embedded automotive platforms, since eBPF does not require large or intrusive kernel modifications. As a result, a compact eBPF-based agent can efficiently monitor and report on critical events to a cloud service for further analysis, enhancing security while preserving system resources.

According to some embodiments of the on-board computer system 14, the novel kernel-level security agent 52, as described herein, is “hooked into” the kernel 50, which may be an existing kernel. The concept of hooking into the kernel, for instance, may be interpreted as rerouting or intercepting system commands or function calls before they reach their intended destination. The term “hooking” in this respect may cover a range of techniques used to alter or augment the behavior of the operating system 46 (or other application or software component) by intercepting function calls, messages, or events passed between software components. Code that handles such intercepted function calls, events or messages can be called a “hook.”

In some cases, hooking may also be used for other purposes, such as for debugging and extending functionality. Examples might include intercepting vehicle status or condition messages before they reach an application, or intercepting operating system calls in order to monitor behavior or modify the function of an application or other component. Hooking into the kernel may also be interpreted as intercepting and modifying the execution flow of the core operating system functions by inserting custom code at specific points, allowing the kernel-level security agent 52 to monitor, alter, or add functionality to system calls before they reach their intended destination. Essentially, it gives the ability to tap into the kernel 50 to influence system behavior at a very low level, such as for monitoring security of the vehicle 12.

In particular, the novelty of this embodiment, for example, may lie in the use of eBPF to monitor embedded systems for security purposes, extending beyond the vehicle's central Linux OS (e.g., to include Electronic Control Units (ECUs)). This comprehensive monitoring capability enhances the security posture of the entire vehicle system.

For vehicles with autopilot features and onboard machine learning, the kernel-level security agent 52 may be configured to perform local threat analysis, utilizing the vehicle's computational resources for immediate detection. Additionally, the kernel-level security agent 52 can transmit data via the wireless communication device 38 (e.g., 5G module) to backend microservices via the cloud-based system 20 for comprehensive logging and further analysis. This comprehensive threat detection can be integrated into the data fabric portion of the vehicle security server 24 as shown in FIG. 2. Therefore, with the kernel-level security agent 52 (e.g., auto shield) and the remotely arranged vehicle security server 24, the vehicle security network 10 is able to offer a hybrid approach to automotive cybersecurity, combining local and cloud-based threat detection to provide robust and scalable protection for vehicles.

Therefore, the vehicle security network 10 may include an eBPF or kernel-level security agent for central access to vehicle operations and parameters. Also, the vehicle security network 10 includes a forwarding module (e.g., wireless communication device 38) to send vehicle data to the cloud (5G). This also includes onboard processing for performing some local processing, blocking, etc.

In this manner, the vehicle security network 10 is configured to resist various types of malicious actions or threats. For example, an attacker may attempt to mess with the operational aspects of the vehicle 12, whereby malicious software can cause problems with self-driving functionality, navigation functionality, and other types of vehicle operation functionality. Other threats may include data exfiltration, whereby malicious software may attempt to intercept or leak Personal Identifiable Information (PII), such as name of driver or passengers, address, social security numbers, Vehicle Identification Number (VIN), where the vehicle has traveled, etc. Also, other attacks may include crypto mining, for example, where malicious software might be used to cause the vehicle computer power to perform mining.

In addition to attacks messing with the vehicle's autonomous systems, self-driving functions, navigation functions, malicious data exfiltration, etc., other types of malicious activity that can be waged against a vehicle's systems may include remote takeover and control attacks (e.g., brake manipulation, accelerator manipulation, sterring hijacking, engine shutdown, etc.). Also, an attacker may exploit the infotainment system, such as by using ransomware attacks to lock access to the infotainment system and demanding payment for restoration, injecting malware, spyware, trojans, etc. via USB, Bluetooth, or Wi-Fi to eavesdrop on communications. These attacks may also involve fake software updates to trick users into installing malicious firmware disguised as an official update.

Other attacks may include GPS spoofing and navigation attacks, such as fake GPS signals, which could redirect a vehicle to a wrong location or preventing GPS-based emergency services from working. This may also include location tracking and stalking attacks where attackers can track the vehicle's location in real time.

Furthermore, attacks may include sensor tampering and false data injection, such as LiDAR and radar spoofing. This may include feeding false data to confuse the vehicle's perception of obstacles and road conditions. It may also include traffic sign manipulation by displaying fake speed limits or stop signs that can trick autonomous systems.

Other attacks may include Vehicle-to-Everything (V2X) attacks (e.g., V2V, V2I, V2N, V2P, V2D, V2C, etc.). This may be seen as Denial-of-Service (DoS) attacks, flooding V2X communication channels to disrupt traffic safety messages. Also, this may include message forgery, such as sending false messages about road conditions, causing unnecessary detours or accidents.

Also, other attacks may include key fob attacks and exploiting locking/unlocking features. For example, a relay attack may include amplifying the signal from a wireless key fob to unlock and start a vehicle remotely. The attack may also include a replay attack, which may include intercepting and replaying signals to gain unauthorized access.

In some cases, other attacks may include Control Area Network (CAN) bus attacks on the local bus 42 and/or Electronic Control Unit (ECU) hacking attacks on the control modules 44. For example, this may include injecting malicious commands in order to gain access to the CAN bus and sending commands to disable safety features. This may also include “bricking” the ECU by overwriting critical firmware to render the vehicle inoperable.

Therefore, according to various implementations, an embedded system (e.g., on-board computer system 14) may be installed on or incorporated within a vehicle. In one implementation, the embedded system may include a wireless transceiver device (e.g., wireless communication device 38) and an operating system 46 that includes at least a kernel 50 and a cybersecurity agent (e.g., kernel-level security agent 52). The cybersecurity agent, for instance, includes minimal resources for contributing base level or lightweight functionality with respect to protection against vehicle cybersecurity attacks. Also, the wireless transceiver device may be configured to offload vehicle data to a cloud-based server (e.g., vehicle security server 24). The cloud-based server, for instance, may be configured for contributing detailed level or heavyweight functionality with respect to protection against the vehicle cybersecurity attacks.

In some embodiments, the cybersecurity agent may be configured to be hooked into the kernel 50 without significantly modifying existing code of the kernel 50. The cybersecurity agent may be configured to leverage privileged code running in a kernel space of the operating system 46. The privileged code, for example, may be extended Berkeley Packet Filter (eBPF) that allows visibility into kernel-level events and kernel-level monitoring.

Furthermore, according to some embodiments, the embedded system within the vehicle 12 may further include on-board sensors 37 configured to detect operational parameters of the vehicle, the operational parameters including at least the vehicle data offloaded to the cloud-based server. For example, the cybersecurity agent may be configured to utilize the operational parameters to locally detect real-time anomalies and potential cybersecurity threats, and the cloud-based server may be configured to utilize the operational parameters to remotely detect additional anomalies and potential cybersecurity threats. The action of detecting the operational parameters may include monitoring system calls, process activity, network traffic, and/or file read/write operations.

The embedded system (e.g., on-board computer system 14) may be arranged in one or more control modules of the vehicle, the one or more control modules including at least an Electronic Control Unit (ECU). In some embodiments, the operating system 46 may be configured in Linux or Automative Grade Linux (AGL). The protection against vehicle cybersecurity attacks, for example, may include defending against a) an autopilot function attack, b) a self-driving function attack, c) an autonomous lane change detection attack, d) a vehicle control module attack, e) a personal data exfiltration attack, f) a Personal Identifiable Information (PII) access or manipulation attack, g) a telematics access or manipulation attack, h) an infotainment system attack, i) a crypto mining attack, j) an on-board Machine Learning (ML) model attack, and/or k) a navigation function attack. In some embodiments, the cybersecurity agent and cloud-based server may be further configured to contribute remediation actions to defend against the vehicle cybersecurity attacks, the remediation actions including a) blocking access to vehicle operations, b) blocking access to personal data, c) preventing writing to config files, d) blocking access to control modules or memory resources, and/or e) blocking false notifications.

The wireless transceiver device, in some embodiments, may include at least a 5G module configured to transmit the vehicle data to the cloud-based server via one or more mobile base stations 16 and/or stationary transportation devices 18. The 5G module, for example, may be further configured to receive analysis results from the cloud-based server, where the analysis results may include security status information and alerts with respect to the protection against the vehicle cybersecurity attacks. The 5G module, for example, may be configured to transmit logs, telemetry, telematics, system calls, network packets, and processes over a cellular connection to the cloud-based server. In some embodiments, the cloud-based server may be configured as a backend server or edge server having one or more microservices for contributing the detailed level or heavyweight functionality with respect to protection against the vehicle cybersecurity attacks. The cybersecurity agent may be configured with open-source code and may be agnostic to vehicle manufacturer and vehicle make and model information.

### Security Service for Multiple Vehicles

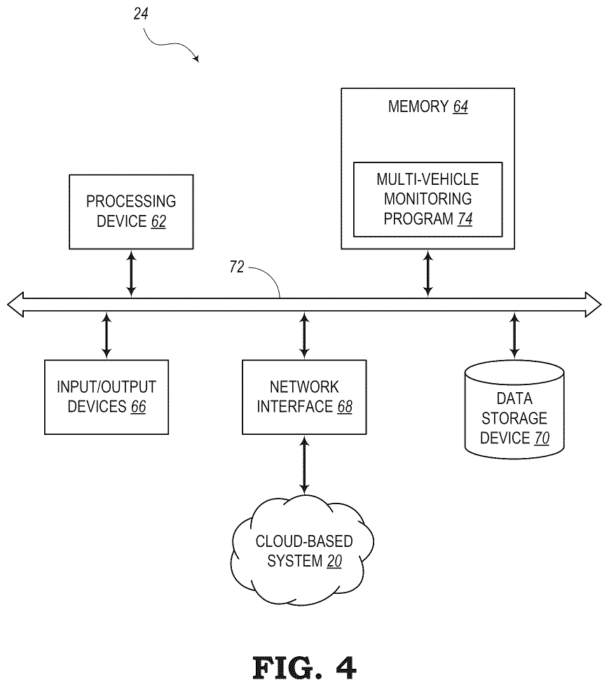

FIG. 4 is a block diagram illustrating an embodiment of the vehicle security server 24 shown in FIG. 1. As shown, the vehicle security server 24 in this embodiment includes a processing device 62, memory 64, I/O devices 66, network interface 68, data storage device 70, each interconnected with each other via a local interface 72. For example, the processing device 62, memory 64, I/O devices 66, and data storage device 70 may include the same or similar functionality as the corresponding components as described with respect to the on-board computer system 14 of FIG. 3.

The vehicle security server 24 may include one or more processing devices configured to execute instructions stored in memory 64, such as a multi-vehicle monitoring program 74. The memory 64 may comprise volatile memory (e.g., RAM) and non-volatile memory (e.g., ROM, flash memory) for storing data and program instructions. The I/O devices 66 may include keyboards, mice, displays, monitors, and other periphery devices, and may be configured to facilitate user interaction with the computer system. Additionally, the network interface 68 may be configured to enable communication with external devices and networks, such as the cloud-based system 20, allowing for data exchange and remote access.

The data storage device 70 may be configured to store and manage data relevant to the cybersecurity services offered. The local interface 72 (e.g., bus) is configured to facilitate communication among the various components of the computer system. In operation, the processing device 62 may be configured to execute instructions retrieved from memory 64, interact with the I/O devices 66, communicate over the network interface 68, access and manipulate data stored in the data storage device 70, and utilize the local interface 72 to coordinate data transfer between components, thereby implementing the cybersecurity functionality.

The multi-vehicle monitoring program 74 may include receiving vehicle data (e.g., vehicle information, driver/passenger information, security concerns, GPS information, etc.) from one or more vehicles and offer heavyweight security processing for remote analysis of vehicle security aspects. Based on the security analysis for each vehicle, the results are passed back to the vehicles (e.g., via the cloud-based system 20, mobile base station 16, etc.).

For example, the multi-vehicle monitoring program 74 may be configured to provide individualized remediation instructions to the vehicles based on the results. Some remediation strategies for preventing or minimizing the various types of attacks mentioned above may include strategies to reduce or eliminate any serious threats to vehicle operation/function as well as preserving sensitive user information (e.g., PII). Some remediation actions to prevent or minimize cyberattacks on vehicles and users may include a multi-layered cybersecurity approach. Some key remediation strategies, for example, may include:

### 1. Secure Vehicle Network & Communication

Encrypt Communications—Use strong encryption (e.g., AES, TLS) for vehicle-to-vehicle (V2V), vehicle-to-infrastructure (V2I), and over-the-air (OTA) updates to prevent eavesdropping and data tampering.
Segment Networks—Isolate critical systems (e.g., braking, steering) from infotainment and non-essential components using firewalls and network segmentation.
Use Secure Authentication—Implement multi-factor authentication (MFA) for remote access and keyless entry systems.

### 2. Strengthen Access Control & Authentication

Use Secure Boot & Code Signing—Ensure that only authenticated and unmodified firmware/software runs on vehicle components.
Limit Administrative Access—Restrict access to ECU and CAN bus communications to authorized entities only.
Key Fob Protection—Use rolling codes and ultra-wideband (UWB) technology to prevent relay attacks.

### 3. Hardening Autonomous Systems & Sensors

Implement Redundant Sensors—Use multiple sensor types (e.g., LiDAR, radar, cameras) with cross-checking algorithms to detect spoofed data.
Anomaly Detection in AI Systems—Train machine learning models to recognize and reject manipulated sensor inputs.
Secure GPS & Navigation—Use cryptographic validation for GPS signals to mitigate spoofing attacks.

### 4. Protect Against CAN Bus & ECU Attacks

Intrusion Detection Systems (IDS)—Deploy real-time anomaly detection for CAN bus traffic to identify unauthorized messages.
Rate-Limiting on Commands—Restrict how frequently critical commands (e.g., brake disable) can be issued within a time frame.
Firmware Integrity Checks—Use hash-based checks to verify ECU firmware integrity at startup.

### 5. Secure Wireless Interfaces & OTA Updates

Harden Bluetooth & Wi-Fi—Disable unused wireless interfaces and use strong authentication for those in use.
Ensure Secure OTA Updates—Implement end-to-end encryption, digital signatures, and strict version control for firmware updates.
Monitor Cellular & V2X Traffic—Use firewalls and anomaly detection for connected vehicle communications.

### 6. Prevent Keyless Entry Exploits

RFID Signal Jamming Detection—Equip vehicles with countermeasures to detect and prevent relay/replay attacks.
Faraday Pouches for Key Fobs—Store key fobs in signal-blocking pouches to prevent signal amplification attacks.
Auto Shut-Off for Proximity Keys—Program key fobs to deactivate when motionless for extended periods.

### 7. Implement Strong Cybersecurity Governance

Regular Penetration Testing—Conduct ethical hacking exercises to identify vulnerabilities before attackers do.
Compliance with Standards—Follow industry frameworks such as:
   ISO/SAE 21434 (Cybersecurity for road vehicles)
   UN Regulation No. 155 (Vehicle cybersecurity management)
   NIST Cybersecurity Framework
      User Education & Awareness—Train users and fleet operators on security best practices (e.g., avoiding public Wi-Fi for telematics access).

### 8. Address Physical Security Risks

Tamper-Resistant Hardware—Use hardware security modules (HSMs) and physically hardened ECUs.
Disable Unused Ports—Restrict access to OBD-II ports and require authentication for diagnostics.
Camera & Biometric Authentication—Implement driver recognition to prevent unauthorized access.

According to various implementations, the present disclosure may be directed to a cloud-based, multi-vehicle server. In one implementation, the cloud-based, multi-vehicle server may include an Application Programming Interface (API) gateway configured to remotely receive vehicle data from each of one or more vehicles. Also, the cloud-based, multi-vehicle server may include a microservice module configured for cybersecurity analysis for each of the one or more vehicles, wherein each of the one or more vehicles may be configured to contribute base level or lightweight functionality with respect to protection against vehicle cybersecurity attacks waged on the respective vehicle. The cloud-based, multi-vehicle server may further include a fabric architecture configured to provide high-speed and efficient interconnection among multiple components of the cloud-based, multi-vehicle server for contributing detailed level or heavyweight functionality with respect to protection against the vehicle cybersecurity attacks.

In some embodiments, each of the vehicles serviced by the cloud-based, multi-vehicle server may include an embedded system installed thereon. The embedded system, for example, may include a) a wireless transceiver device for communication with the API gateway and b) an operating system including at least a kernel and a cybersecurity agent. The cybersecurity agent, for example, may include minimal resources for contributing the base level or lightweight functionality.

### Additional Considerations

In addition to rudimentary cybersecurity measures that can be handled by resource-constrained hardware and/or software on a vehicle, cloud-based protection for vehicles can also be offered for more detailed or comprehensive cybersecurity issues. For example, the systems and methods described herein are configured for providing protection against attacks with respect to self-driving capabilities, personal data preservation, etc. Currently, there is little (if any) systems that provide cybersecurity for embedded systems of motor vehicles. Therefore, there is a need for greater security with self-driving systems, personal safety of vehicle operation, Personal Identifiable Information (PII) (e.g., name, VIN, location, etc.).

Automotive Grade Linux (AGL), Android-based Linux, Apple-based Linux, etc. may be installed in an open-source format in the operating system of a vehicle having a fully functioning computing system or embedded system. Deploying endpoint security software, according to the concepts described in the present disclosure, may be done in a broad manner to accommodate any suitable operating system, any suitable vehicle manufacturer, any suitable vehicle make, model, and year, etc. One goal of the systems and methods described herein is that the on-board resources do not need to be able to handle heavyweight processing, but rather may be resource-constrained. Thus, much of the intense processing may be offloaded to the remote server, which can analyze cybersecurity for multiple vehicles in parallel. Also, the on-board cybersecurity agent can be generic kernel-level code that can be hooked onto any suitable kernel of any suitable operating system, again allowing widespread distribution to any type of embedded system, such as one installed in a vehicle.

Also, by providing generic code, as described herein, it would not be necessary for a developer to implement customized kernel modules in each vehicle, which might be based on manufacturer, make, model, etc. The eBPF agent described herein can tap into the kernel to read the system information (e.g., system calls, socket connection information, etc.). Also, it can provide a lot more information without the need to modify the existing kernel code, which would otherwise be required by the manufacturer or the development team that creates the entire Linux system.

Again, the vehicle-based cybersecurity agent and operating system would not be as powerful as a cluster that might be used in a data center for providing cloud-based processing. Therefore, the systems and method support the idea of keeping the cybersecurity agent as lightweight as possible. Thus, the agent will be able to do simple task, such as queries, retrieving information, etc. Then, using 5G (e.g., which may already be available on many new vehicles), the data can be streamed out through 5G and security analysis can be run remotely. At this point, results can be sent back to the vehicles for informing the driver and passengers of any pending issues.

### Conclusion

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. An embedded system installed on or incorporated within a vehicle, the embedded system comprising:
a wireless transceiver device; and
an operating system including at least a kernel and a cybersecurity agent;
wherein the cybersecurity agent includes minimal resources for contributing base level or lightweight functionality with respect to protection against vehicle cybersecurity attacks, and
wherein the wireless transceiver device is configured to offload vehicle data to a cloud-based server, the cloud-based server configured for contributing detailed level or heavyweight functionality with respect to protection against the vehicle cybersecurity attacks.

2. The embedded system of claim 1, wherein the cybersecurity agent is configured to be hooked into the kernel without significantly modifying existing code of the kernel.

3. The embedded system of claim 1, wherein the cybersecurity agent is configured to leverage privileged code running in a kernel space of the operating system.

4. The embedded system of claim 3, wherein the privileged code is extended Berkeley Packet Filter (eBPF) that allows visibility into kernel-level events and kernel-level monitoring.

5. The embedded system of claim 1, further comprising on-board sensors configured to detect operational parameters of the vehicle, the operational parameters including at least the vehicle data offloaded to the cloud-based server.

6. The embedded system of claim 5, wherein the cybersecurity agent is configured to utilize the operational parameters to locally detect real-time anomalies and potential cybersecurity threats, and wherein the cloud-based server is configured to utilize the operational parameters to remotely detect additional anomalies and potential cybersecurity threats.

7. The embedded system of claim 5, wherein detecting the operational parameters includes monitoring system calls, process activity, network traffic, and file read/write operations.

8. The embedded system of claim 1, wherein the embedded system is arranged in one or more control modules of the vehicle, the one or more control modules including at least an Electronic Control Unit (ECU).

9. The embedded system of claim 1, wherein the operating system is configured in Linux or Automative Grade Linux (AGL).

10. The embedded system of claim 1, wherein protection against vehicle cybersecurity attacks includes defending against one or more of a) an autopilot function attack, b) a self-driving function attack, c) an autonomous lane change detection attack, d) a vehicle control module attack, e) a personal data exfiltration attack, f) a Personal Identifiable Information (PII) access or manipulation attack, g) a telematics access or manipulation attack, h) an infotainment system attack, i) a crypto mining attack, j) an on-board Machine Learning (ML) model attack, and k) a navigation function attack.

11. The embedded system of claim 1, wherein the cybersecurity agent and cloud-based server are further configured to contribute remediation actions to defend against the vehicle cybersecurity attacks, the remediation actions including one or more of a) blocking access to vehicle operations, b) blocking access to personal data, c) preventing writing to config files, d) blocking access to control modules or memory resources, and e) blocking false notifications.

12. The embedded system of claim 1, wherein the wireless transceiver device includes at least a 5G module configured to transmit the vehicle data to the cloud-based server via one or more mobile base stations and/or stationary transportation devices, the 5G module further configured to receive analysis results from the cloud-based server, the analysis results including security status information and alerts with respect to the protection against the vehicle cybersecurity attacks.

13. The embedded system of claim 12, wherein the 5G module is configured to transmit logs, telemetry, telematics, system calls, network packets, and processes over a cellular connection to the cloud-based server.

14. The embedded system of claim 1, wherein the cloud-based server is configured as a backend server or edge server having one or more microservices for contributing the detailed level or heavyweight functionality with respect to protection against the vehicle cybersecurity attacks.

15. The embedded system of claim 1, wherein the cybersecurity agent is configured with open-source code and is agnostic to vehicle manufacturer and vehicle make and model information.

16. A vehicle operating system comprising:
a kernel; and
a cybersecurity agent having minimal resources for contributing base level or lightweight functionality with respect to protection against vehicle cybersecurity attacks;
wherein a wireless transceiver device is configured to offload vehicle data to a cloud-based server, the cloud-based server configured for contributing detailed level or heavyweight functionality with respect to protection against the vehicle cybersecurity attacks.

17. The vehicle operating system of claim 16, wherein the cybersecurity agent is configured to be hooked into the kernel without significantly modifying existing code of the kernel, wherein the cybersecurity agent is configured to leverage privileged code running in a kernel space of the vehicle operating system, and wherein the privileged code is extended Berkeley Packet Filter (eBPF) that allows visibility into kernel-level events and kernel-level monitoring.

18. The vehicle operating system of claim 16, wherein the vehicle operating system is configured as Linux or Automative Grade Linux (AGL).

19. A cloud-based, multi-vehicle server comprising:
an Application Programming Interface (API) gateway configured to remotely receive vehicle data from each of one or more vehicles;
a microservice module configured for cybersecurity analysis for each of the one or more vehicles, wherein each of the one or more vehicles is configured to contribute base level or lightweight functionality with respect to protection against vehicle cybersecurity attacks waged on the respective vehicle; and
a fabric architecture configured to provide high-speed and efficient interconnection among multiple components of the cloud-based, multi-vehicle server for contributing detailed level or heavyweight functionality with respect to protection against the vehicle cybersecurity attacks.

20. The cloud-based, multi-vehicle server of claim 19, wherein each of the one or more vehicles includes an embedded system installed thereon, the embedded system including a) a wireless transceiver device for communication with the API gateway and b) an operating system including at least a kernel and a cybersecurity agent, the cybersecurity agent including minimal resources for contributing the base level or lightweight functionality.
